(19) United States
(12) Patent Application Publication
(10) Pub. No.: US 2003/0126203 A1
(43) Pub. Date: Jul. 3, 2003

(54) Server system with geographical location service and method of using the same

(75) Inventors: Sayling Wen, Taipei (TW); Kuang-Shin Lin, Taipei (TW)

Correspondence Address: THE LAW OFFICES OF MIKIO ISHIMARU, 1110 SUNNYVALE-SARATOGA ROAD, SUITE A1, SUNNYVALE, CA, 94087, US

(73) Assignee: Inventec Corporation, Taipei (TW)

(21) Appl. No.: 10/302,525

(22) Filed: Nov. 21, 2002

(30) Foreign Application Priority Data
Dec. 28, 2001 (TW) 90132714

(51) Int. Cl. G06F 15/16

(52) U.S. Cl. 709/203

(57) ABSTRACT

A server system with geographical location service and a method of using the server system are proposed and applicable to an Internet environment. The server system having a domain name geographical system, includes one or more interconnected sub systems, wherein each sub system is provided with one or more interconnected process terminals. Each process terminal is designated with a domain name, a TCP/IP address, and latitude and longitude data of geographical location corresponding to the process terminal. Such a server system cooperatively operates through interconnected sub systems in a manner that, data of actual geographical distance between every two process terminals of the sub systems can be determined by the domain name geographical system, allowing the server system to provide network-related service as well as mapping service in association of geographical location and actual distance.

### FIELD OF THE INVENTION

The present invention relates to server systems and methods of using the same, and more particularly, to a server system with geographical location service and a method of using the server system, applicable to an Internet environment, so as to provide network-related service as well as mapping service in association of geographical location and actual distance.

### BACKGROUND OF THE INVENTION

Generally, a hierarchical framework is employed to construct domain names in a domain name system (DNS), so as to enable a user to easily find data distributed in a database. A top-level domain indicates the most general classification in the database. For example, a domain name that ends with “com” represents a commercial corporation or enterprise; in consideration of www.microsoft.com, “com” is a top-level domain and “microsoft” is a subdomain. A registered domain name is provided with corresponding data, mostly a TCP/IP (Transmission Control Protocol/Internet Protocol) address, in the DNS database. Each DNS database has a list of other DNS servers for inquiry use. This is because, a DNS server would not contain a complete DNS hierarchical structure; when the DNS server receives an unreadable request, it can search in other DNS servers for obtaining requested data.

As shown in FIG. 1, a conventional server platform with DNS service is a tree network system, wherein a tree search is implemented for the DNS service. For example, when a server 31 at a third layer is unable to conduct a search for a TCP/IP address corresponding to a requested domain name, it would send this search request to an upper-layer server i.e. server 21 at a second layer for searching the TCP/IP address as requested. If the requested TCP/IP address cannot be retrieved by the server 21, this search request would be further forwarded to a server 11 at a first layer for TCP/IP address retrieval. If the server 11 still cannot find the TCP/IP address corresponding to the requested domain name, it would produce an error message indicating failure in searching a server compliant with the requested domain name, which error message is then transmitted from the server 11 to the server 21 at the second layer, in turn from the server 21 to the server 31 at the third layer, and finally from the server 31 to a user. In the DNS server system of FIG. 1, each server, such as the server 11 (first layer), server 21 (second layer) or server 31 (third layer), only provides the DNS service but cannot realize correlation in actual geographical location with one another. Therefore, if a geographical factor is considered for performing electronic commerce (e-commerce), the DNS server system would not attain to the most time-efficient and cost-effective service.

For example, when the user conducts e-commerce trading with and sends a purchase request to a server 32 at the third layer, upon receiving the purchase request from the user, the server 32 would mail purchased goods to the user. In the case of the user being located geographically away from the server 32 by 500 km but away from a server 33 by 100 km, if the server 32 is capable of forwarding the purchase request from the user to the server 33, more time-efficient and cost-effective delivery of goods would be achieved by the DNS server system. Thereby, if the DNS server system realizes actual geographical location of each server, e-commerce business can be more profitably performed by reducing transportation costs.

Furthermore, if a user requests for downloading data from the server 31 at the third layer, upon receiving the data-downloading request from the user, the server 31 would transmit requested data to the user through a network. However, in concern of efficient data delivery, if the server 31 is not the server located nearest to the user, and the server 31 is relatively busy and narrow in network bandwidth with respect to the user, a geographically closer server e.g. server 34 that contains requested data and has wider bandwidth with respect to the user, would be more preferable to direct the requested data to user. Thereby, if the DNS server system realizes actual geographical location of each server, allowing the server 31 to forward the data-downloading request from the user to the server 34, data can be more efficiently delivered to the user for downloading as requested.

Therefore, how to overcome the above drawbacks of using the conventional server system that is not capable of identifying servers' geographical locations, and to improve data transmission efficiency and cost effectiveness for e-commerce business in concern of geographical and network bandwidth factors, is a critical problem to solve in the art.

### SUMMARY OF THE INVENTION

An objective of the present invention is to provide a server system with geographical location service and a method of using the same, applicable to an Internet environment, wherein the server system with a domain name geographical system cooperatively operates through interconnected sub systems in a manner that, data of actual geographical distance between every two process terminals of the sub systems can be determined by the domain name geographical system, allowing the server system to provide network-related service as well as mapping service in association of geographical location and actual distance.

Another objective of the present invention is to provide a server system with geographical location service and a method of using the same, applicable to an Internet environment, wherein the server system can identify actual geographical locations for process terminals that provide service for a user as requested, so as to improve data transmission efficiency in concern of a geographical factor.

A further objective of the present invention is to provide a server system with geographical location service and a method of using the same, applicable to an Internet environment, wherein the server system can identify actual geographical locations for process terminals that provide service for a user as requested, so as to improve cost effectiveness for electronic commerce (e-commerce) business in concern of a geographical factor.

In accordance with the above and other objectives, the present invention proposes a new server system with geographical location service and a method of using the same, applicable to an Internet environment.

The server system with the geographical location service includes one or more interconnected sub systems, and each sub system is provided with one or more interconnected process terminals. Each process terminal is designated with a unique TCP/IP address, and latitude and longitude data of actual geographical location corresponding to the process terminal. That is, besides a domain name system (DNS), a database of each process terminal also contains a domain name geographical system that stores a table containing a domain name and geographical location data for the process terminal.

In operation, the server system having a domain name geographical system cooperatively operates through interconnected sub systems in a manner that, data of actual geographical distance between every two process terminals of the sub systems can be determined by the domain name geographical system, allowing the server system to provide network-related service as well as mapping service in association of geographical location and actual distance.

Moreover, the server system with the domain name geographical system the server system can identify actual geographical locations for process terminals that provide service for a user as requested, so as to improve data transmission efficiency and cost effectiveness for electronic commerce (e-commerce) business in concern of a geographical factor.

### BRIEF DESCRIPTION OF THE DRAWINGS

The present invention can be more fully understood by reading the following detailed description of the preferred embodiments, with reference made to the accompanying drawings, wherein:

FIG. 1 (PRIOR ART) is a systemic diagram illustrating a tree structure of a conventional server platform system;

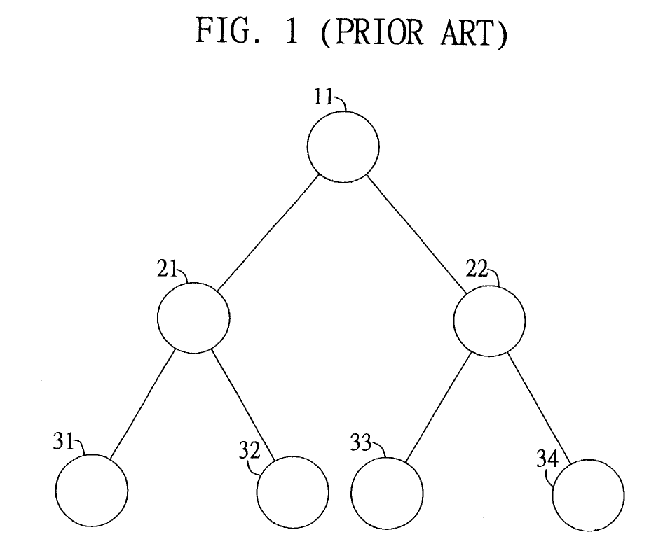

FIG. 2 is a systemic diagram illustrating a server system with geographical location service of the invention;

FIG. 3 is a structural diagram illustrating a sub system of FIG. 2;

FIG. 4 is a table illustrating data of domain name, TCP/IP, and latitude and longitude of actual geographical location for process terminals of FIG. 3;

FIG. 5 is a systemic diagram illustrating basic system configuration for an embodiment of the server system of FIG. 2;

FIG. 6 is a table illustrating data of TCP/IP and latitude and longitude of actual geographical location for process terminals of FIG. 5;

FIG. 7 is a table illustrating data of domain name and latitude and longitude of actual geographical location for process terminals of FIG. 5;

FIG. 8 is a table illustrating data of domain name, TCP/IP, and latitude and longitude of actual geographical location for process terminals of FIG. 5;

FIG. 9 is a flowchart illustrating process steps involved in data transmission through the use of the server system of FIG. 5;

FIG. 10 is a systemic diagram illustrating basic system configuration for another embodiment of the server system of FIG. 2;

FIG. 11 is a table illustrating data of domain name, TCP/IP, and latitude and longitude of actual geographical location for process terminals of FIG. 10; and

FIG. 12 is a flowchart illustrating process steps involved in electronic commerce trading through the use of the server system of FIG. 10.

### DETAILED DESCRIPTION OF THE PREFERRED EMBODIMENTS

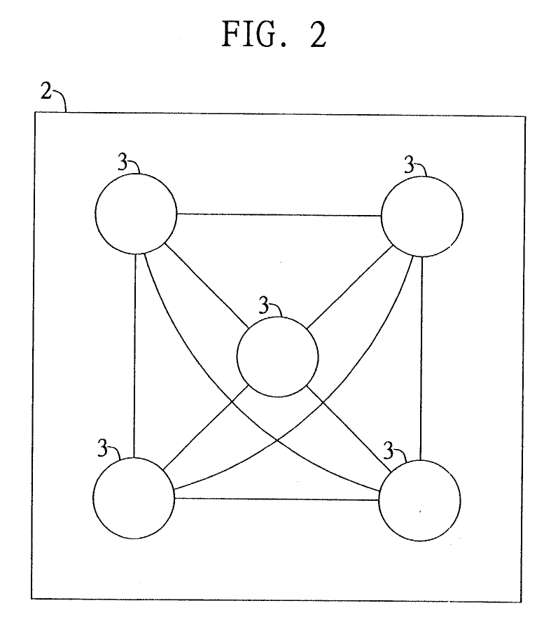

FIG. 2 illustrates a server system with geographical location service of the present invention. As shown in the drawing, the server system 2 contains one or more interconnected sub systems 3 of a topological form, wherein every two sub systems 3 are linked by a network for data transmission. And, the sub systems 3 are allowed to properly respond to user's requests, so as to provide users with optimal service. Preferably, a sub system 3 can be a Microsoft NT server system, Microsoft 2000 series or advanced series server system, UNIX system, or Linux server system; and TCP/IP communication protocol can be used for linkage and communication between sub systems 3.

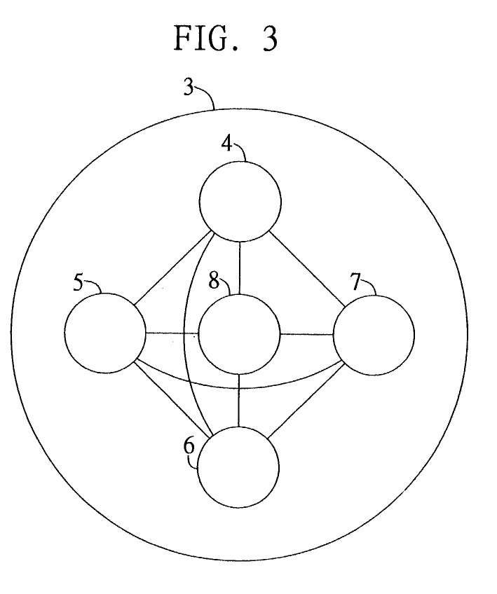

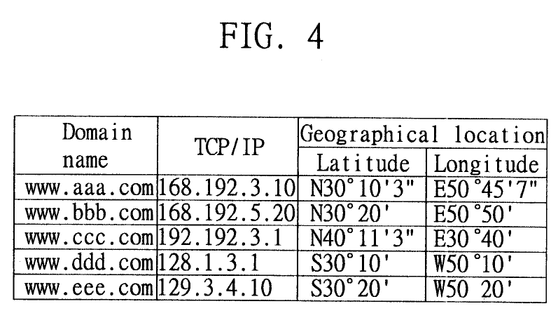

FIG. 3 illustrates a sub system shown in FIG. 2. As shown in the drawing, the sub systems 3 contains one or more interconnected process terminals 4, 5, 6, 7, 8. Besides a unique TCP/IP address, each of the process terminals 4, 5, 6, 7, 8 is also assigned with latitude and longitude corresponding to its actual geographical location. For example, the process terminal 4 has a TCP/IP address of 168.192.3.10, and its actual geographical location at latitude 30°10′3″ North (N) and longitude 50°45′7″ East (E); the process terminal 7 has a TCP/IP address of 128.1.3.1, and is located at latitude 30°10′ South (S) and longitude 50°20′ West (W), as listed in FIG. 4 for more data of TCP/IP address and geographical location for other process terminals. Preferably, a process terminal can be a Microsoft NT server, Microsoft 2000 series or advanced series server, UNIX server, or Linux server; and TCP/IP communication protocol can be used for linkage and communication between process terminals 4, 5, 6, 7, 8.

Therefore, besides a domain name system (DNS), a database of each process terminal 4, 5, 6, 7, 8 is also provided with a domain name geographical system; this domain name geographical system stores a table containing data of a domain name, a TCP/IP address corresponding to the domain name, and latitude and longitude of an actual geographical location for each of the process terminals 4, 5, 6, 7, 8.

FIG. 4 is a table illustrating data of domain name, TCP/IP, and latitude and longitude of actual geographical location for process terminals of FIG. 3. As shown in the drawing, for example, the process terminal 4 has a domain name of www.aaa.com, a TCP/IP address of 168.192.3.10, and its actual geographical location at latitude 30°10′3″ N and longitude 50°45′7″ E. The process terminal 5 has a domain name of www.bbb.com, a TCP/IP address of 168.192.5.20, and its actual geographical location at latitude 30°20′ N and longitude 50°50′ E. The process terminal 6 has a domain name of www.ccc.com, a TCP/IP address as 192.192.3.10, and actual geographical location at latitude 40°11′3″ N and longitude 30°40′ E. The process terminal 7 has a domain name of www.ddd.com, a TCP/IP address of 128.1.3.1, and is located at latitude 30°10′ S and longitude 50°20′ W. The process terminal 8 has a domain name of www.eee.com, a TCP/IP address of 129.3.4.10, and is located at latitude 30°20′ S and longitude 50°20′ W. Therefore, actual geographical location distance between two process terminals can be calculated through the above provided data of geographical locations (latitude and longitude) for the process terminals 4, 5, 6, 7, 8.

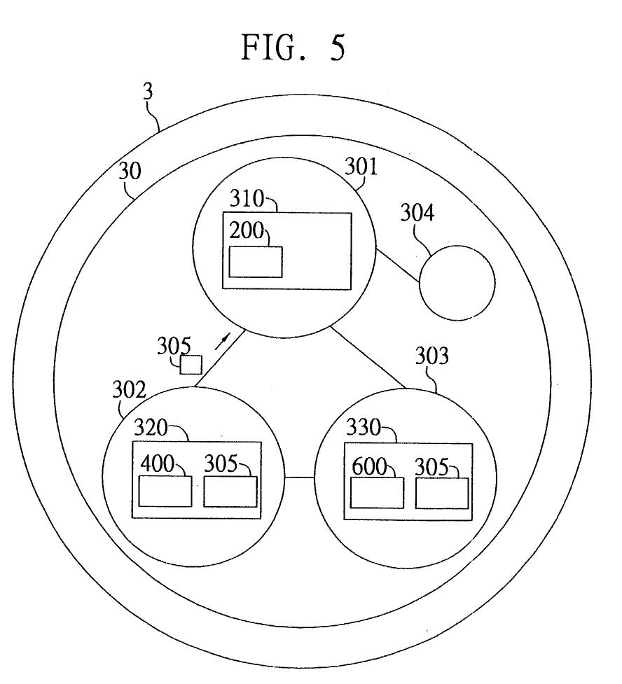

FIG. 5 illustrates basic system configuration for an embodiment of the server system of FIG. 2. As shown in the drawing, the server system 3 with the geographical location service has a sub system 30. The sub system 30 contains a plurality of process terminals 301, 302, 303, wherein each of the process terminals 301, 302, 303 has a database 310, 320, 330, with a table 200, 400, 600 being respectively stored in the database 310, 320, 330.

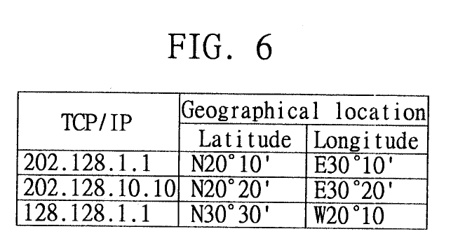

The table 200 of FIG. 6 illustrates data of TCP/IP and latitude and longitude of actual geographical location. As shown in the drawing, the process terminal 301 has a TCP/IP address of 202.128.1.1, and its actual geographical location at latitude 20°10′ N and longitude 30°10′ E; the process terminal 302 has a TCP/IP address of 202.128.10.10, and is located at latitude 20°20′ N and longitude 30°20′ E; and the process terminal 303 has a TCP/IP address of 202.128.1.1, and is located at latitude 30°30′ N and longitude 20°10′ W.

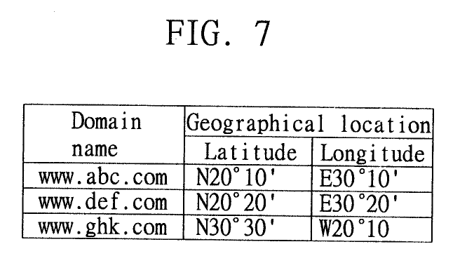

The table 400 of FIG. 7 illustrates data of domain name and latitude and longitude of actual geographical location. As shown in the drawing, the process terminal 301 has a domain name of www.abc.com, and its actual geographical location at latitude 20°10′ N and longitude 30°10′ E; the process terminal 302 has a domain name of www.def.com, and is located at latitude 20°20′ N and longitude 30°20′ E; and the process terminal 303 has a domain name of www.ghk.com, and is located at latitude 30°30′ N and longitude 20°10′ W.

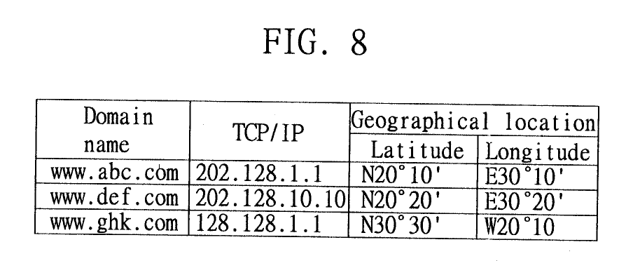

The table 600 of FIG. 8 illustrates data of domain name, TCP/IP, and latitude and longitude of actual geographical location. As shown in the drawing, the process terminal 301 has a domain name of www.abc.com, a TCP/IP address of 202.128.1.1, and its actual geographical location at latitude 20°10′ N and longitude 30°10′ E. The process terminal 302 has a domain name of www.def.com, a TCP/IP address of 202.128.10.10, and is located at latitude 20°20′ N and longitude 30°20′ E. The process terminal 303 has a domain name of www.ghk.com, a TCP/IP address of 202.128.1.1, and is located at latitude 30°30′ N and longitude 20°10′ W.

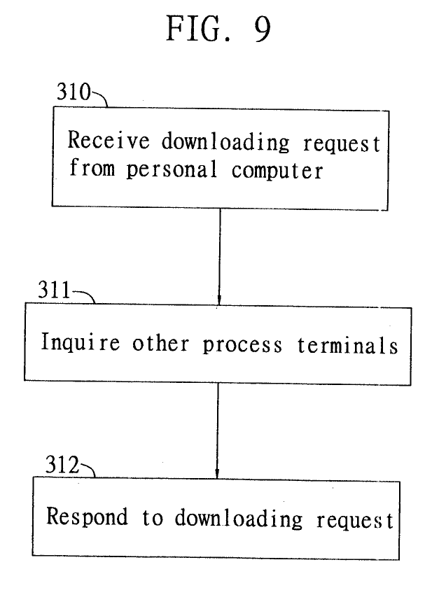

FIG. 9 illustrates process steps involved in data transmission through the use of the server system of FIG. 5. A process is here exemplified for allowing a user of a personal computer (PC) 304 being served by a process terminal 301 to download a file 305. As shown in the drawing, first in step 310, the process terminal 301 of a sub system 30 of the server system 3 with the geographical location service, receives a request for downloading the file 305 from the user of the PC 304. Then, the process moves on to step 311.

In step 311, the process terminal 301 processes the request for downloading the file 305. Upon receiving the file-downloading request from the PC 304, if the process terminal 301 does not have the file 305, it would inquire process terminals 302, 303 for the file 305. After receiving the inquiry from the process terminal 301, the process terminals 302, 303 would examine their own file content, and send a message to the process terminal 301 if the file 305 is found. Then, the process moves on to step 312.

In step 312, the process terminal 301 responds to the request for downloading the file 305. By using a table 200, 400 or 600 (as shown in FIG. 6, 7 or 8), the process terminal 301 can determine that the process terminal 302 is geographically closest to the process terminal 301, such that the file 305 would be transferred from the process terminal 302 through the process terminal 301 to the user of the PC 304. This completes the process of file or data transmission.

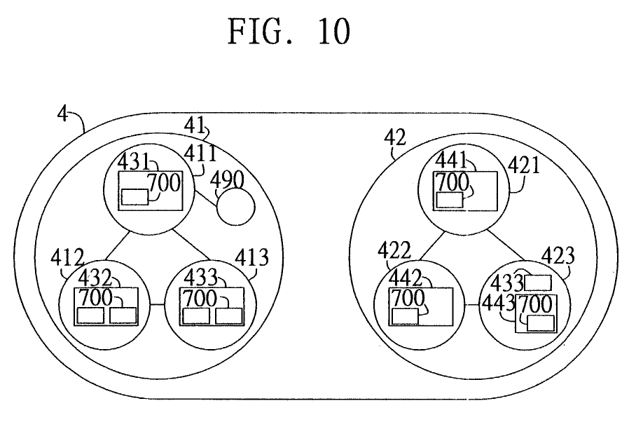

FIG. 10 illustrates basic system configuration for another embodiment of the server system of FIG. 2. As shown in the drawing, the server system 4 is formed with sub systems 41, 42. The sub system 41 contains process terminals 411, 412, 413, and the sub system 42 contains process terminals 421, 422, 423, wherein each of the process terminals 411, 412, 413, 412, 422, 423 has a database 431, 432, 433, 441, 442, 443, respectively. And, a table 700 is provided for each of the databases 431, 432, 433, 441, 442, 443.

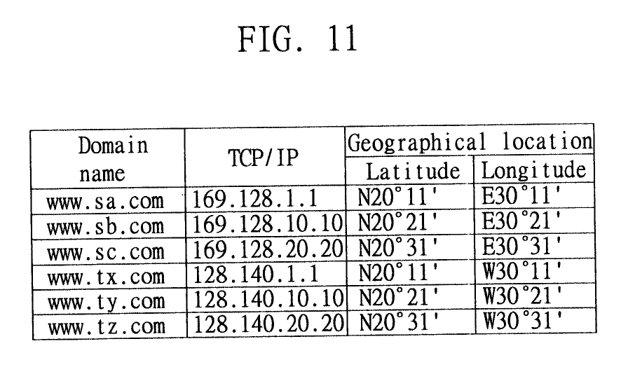

The table 700 of FIG. 11 illustrates data of domain name, TCP/IP, and latitude and longitude of actual geographical location. As shown in the drawing, the process terminal 411 has a domain name of www.sa.com, a TCP/IP address of 169.128.1.1, and its actual geographical location at latitude 20°11′ N and longitude 30°11′ E. The process terminal 412 has a domain name of www.sb.com, a TCP/IP address of 169.128.10.10, and is located at latitude 20°21′ N and longitude 30°21′ E. The process terminal 413 has a domain name of www.sc.com, a TCP/IP address of 169.128.20.20, and is located at latitude 20°31′ N and longitude 30°31′ E. The process terminal 421 has a domain name of www.tx.com, a TCP/IP address of 128.140.1.1, and is located at latitude 20°11′ N and longitude 30°11′ W. The process terminal 422 has a domain name of www.ty.com, a TCP/IP address of 128.140.10.10, and is located at latitude 20°21′ N and longitude 30°21′ W. The process terminal 423 has a domain name of www.tz.com, a TCP/IP address of 128.140.20.20, and its actual geographical location at latitude 20°31′ N and longitude 30°31′ W.

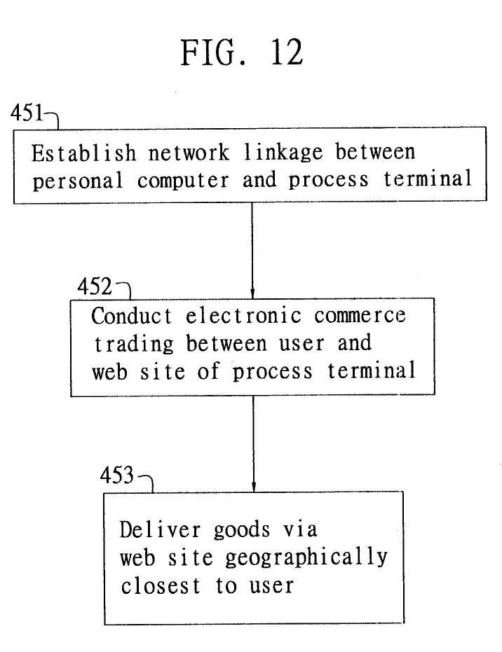

FIG. 12 illustrates process steps involved in electronic commerce trading through the use of the server system of FIG. 10. A user of a personal computer (PC) 490 is linked to a process terminal 411 for establishing connection to Internet, so as to perform electronic commerce (e-commerce) trading with other web sites. As shown in the drawing, first in step 451, the user of the PC 490 is linked to a network server, i.e. the process terminal 411. Then, the process moves on to step 452.

In step 452, the user of the PC 490 would be connected through the process terminal 411 to a web site www.tzl.com of a process terminal 423, for conducting the e-commerce trading. Then, the process moves on to step 453.

In step 453, after the e-commerce trading is completed between the user of the PC 490 and the web site www.tzl.com of the process terminal 423, in consideration of actual geographical location for delivery of goods purchased by the user, the process terminal 423 would process goods delivery through a mirror site www.sbl.com located at a process terminal 412 that is geographically closer to the process terminals 411, as compared to geographical distance between the process terminals 423 and 411. Thereby, purchased goods would be more cost-effectively transported by the mirror site of the process terminal 412 to the user of the PC 490, making the e-commerce trading more profitable to implement. In conclusion, the use of the server system with the geographical location service of the invention provides significant advantages. First, the server system having a domain name geographical system is applied to Internet, and cooperatively operates through interconnected sub systems in a manner that, data of actual geographical distance between every two process terminals of the sub systems can be determined by the domain name geographical system, allowing the server system to provide network-related service as well as mapping service in association of geographical location and actual distance. Moreover, the server system can identify actual geographical locations for process terminals that provide service for a user as requested, so as to improve data transmission efficiency and cost effectiveness for electronic commerce (e-commerce) business in concern of a geographical factor.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method of using a server system with geographical location service, applicable to an Internet environment for data transmission, comprising the steps of:
(1) receiving a request for data transmission via the server system with the geographical location service from a user that is linked to the server; and
(2) processing the request for data transmission via the server system with the geographical location service, according to geographical location data stored in the server system.

2. The method of claim 1, wherein the server system comprises a plurality of interconnected sub systems, and each of the sub systems contains geographical location data.

3. The method of claim 2, wherein in the step (2), the request for data transmission is processed through a sub system that is geographically closest to the user.

4. The method of claim 2, wherein the sub system comprises a plurality of interconnected process terminals, and each of the process terminals contains geographical location data.

5. The method of claim 4, wherein the geographical location data comprise TCP/IP (Transmission Control Protocol/Internet Protocol) addresses, and latitude and longitude data of corresponding geographical locations.

6. The method of claim 4, wherein the geographical location data comprise domain names, and latitude and longitude data of corresponding geographical locations.

7. The method of claim 4, wherein the geographical location data comprise domain names, TCP/IP addresses, and latitude and longitude data of the corresponding geographical locations.

8. A method of using a server system with geographical location service, applicable to an Internet environment for conducting electronic commerce trading, comprising the steps of:
(1) linking an user to the server system with the geographical location service via a network, allowing the user to enter a web site of the server system for conducting electronic commerce trading; and
(2) delivering traded goods to the user via the server system with the geographical location service according to geographical location data stored in the server system, after the user completes the electronic commerce trading with the web site.

9. The method of claim 8, wherein the server system comprises a plurality of interconnected sub systems, and each of the sub systems contains geographical location data.

10. The method of claim 9, wherein in the step (2), traded goods are delivered through a web site of a sub system that is geographically closest to the user.

11. The method of claim 10, wherein the web site for goods delivery is a mirror site corresponding to the web site where the electronic commerce trading is conducted.

12. The method of claim 9, wherein the sub system comprises a plurality of interconnected process terminals, and each of the process terminals contains geographical location data.

13. The method of claim 12, wherein the geographical location data comprise TCP/IP addresses, and latitude and longitude data of corresponding geographical locations.

14. The method of claim 12, wherein the geographical location data comprise domain names, and latitude and longitude data of corresponding geographical locations.

15. The method of claim 12, wherein the geographical location data comprise domain names, TCP/IP addresses, and latitude and longitude data of the corresponding geographical locations.

16. A server system with geographical location service, applicable to an Internet environment, for providing an user with service of data transmission and electronic commerce trading; the server system comprising:
a plurality of interconnected sub systems, wherein the sub systems are linked to each other in a topological form by a network, and each of the sub systems contains geographical location data.

17. The server system of claim 16, wherein the sub system comprises:
a plurality of interconnected process terminals, each of the process terminals having a database that stores a TCP/IP address and latitude and longitude data of geographical location corresponding to the process terminal.

18. The server system of claim 16, wherein the sub system comprises:
a plurality of interconnected process terminals, each of the process terminals having a database that stores a domain name and latitude and longitude data of geographical location corresponding to the process terminal.

19. The server system of claim 16, wherein the sub system comprises:
a plurality of interconnected process terminals, each of the process terminals having a database that stores a domain name, a TCP/IP address, and latitude and longitude data of geographical location corresponding to the process terminal.
